(19) United States
(12) Patent Application Publication
(10) Pub. No.: US 2020/0190387 A1
(43) Pub. Date: Jun. 18, 2020

(54) GRAVEL PACKING FLUID COMPOSITIONS AND METHODS OF USE THEREOF

(71) Applicant: Roger A. Daar, JR., The Woodlands, TX (US)

(72) Inventor: Roger A. Daar, JR., The Woodlands, TX (US)

(21) Appl. No.: 16/708,940

(22) Filed: Dec. 10, 2019

Related U.S. Application Data
(60) Provisional application No. 62/778,476, filed on Dec. 12, 2018.

(51) Int. Cl. C09K 8/38; E21B 43/04

(52) U.S. Cl. CPC C09K 8/38; C09K 8/32; E21B 43/04

(57) ABSTRACT

A composition for use in performing gravel packing operations of boreholes is disclosed. The composition is a mixture of nitrogen gas or carbon dioxide gas, Y-grade fluids mixture, and a surfactant foaming agent. In other embodiments, a high density, non-toxic, inert gas compound can be added to the mixture. Alternatively, a flame retardant chemical can be added to the mixture, as well as a gas or chemical additive that alters the mixture's thermal properties. The composition may be further supplemented with organo-silicate nanoparticles.

### BACKGROUND OF THE INVENTION

Gravel packs are employed to mitigate sand influx during oil and gas well production operations. The annulus between the production screen/liner and the borehole is packed with gravel during “completion operations” to inhibit the passage of formation sand into the production system.

Conventional gravel packing fluids typically are water-based viscous polymer gels or viscosified water that suspends and carries gravel particles down the wellbore. During gravel packing operations, formation damage can occur through the processes of “clay swelling” and/or polymer residue deposition.

Clay swelling can occur when clay minerals contained within reservoir rock pore networks contact water via the gravel packing fluid forced into the reservoir. After contact with water, these swollen clay minerals can occupy a volume several orders of magnitude greater than in their unaltered state. This clay volume expansion can create an annulus of reduced rock permeability surrounding the wellbore, the severity of which depends upon gravel pack fluid penetration depth, contact time between the fluid and clay minerals, and the type of clay minerals.

Polymer residue deposition occurs when the gravel packing gel does not entirely break down and is not entirely expelled when the well is placed on production. These macromolecules remain stuck to the reservoir rock pore network surface and like clay swelling, reduce the pore throat cross-sectional area open to flow and thus reduces reservoir rock permeability.

The gravel packing operation requires that fluid be forced into the reservoir to place the gravel using the permeable reservoir rock as a solid/liquid filtration medium. Permeability damage with conventional gravel packing methods is therefore almost unavoidable and can extend deep into reservoir rock.

The permeability damaged annulus around the wellbore that results from gravel packing operations contains pore networks with constricted cross-sectional areas that create an additional pressure drop which impedes flow from the reservoir into the wellbore and reduces oil and gas well production rates.

Removing water from the gravel packing fluid composition would thereby remove the means by which both clay minerals swell and block pore throats and polymer residue is deposited within pore networks. The inventive composition thereby provides a gravel packing fluid that does not contain water and inhibits this clay swelling and polymer deposition, leaving pore network permeability unaltered and delivering oil and gas wells that produce at higher rates than if those same wells were gravel packed using conventional fluids.

### SUMMARY OF THE INVENTION

In a first embodiment of the invention, the present invention provides for a composition comprising a mixture of nitrogen gas or carbon dioxide gas, Y-grade fluids mixture, and a surfactant foaming agent.

In a second embodiment of the invention, there is disclosed a composition comprising a mixture of nitrogen gas or carbon dioxide gas, Y-grade fluids mixture, a surfactant foaming agent and a high density, non-toxic, inert gas compound.

In a third embodiment of the invention, there is disclosed a composition comprising a mixture of nitrogen gas or carbon dioxide gas, Y-grade fluids mixture, and a flame retardant chemical

In a fourth embodiment of the invention, there is disclosed a composition comprising a mixture of nitrogen gas or carbon dioxide gas, Y-grade fluids mixture, and an organo-silicate nanoparticle.

In another embodiment of the invention, there are disclosed improved methods for performing gravel packing of boreholes comprising adding the inventive compositions to the boreholes.

In general, Y-grade fluids comprise: ethane, wherein the ethane comprises about 30% to 80% of the fluid; propane, wherein the propane comprises about 15% to 50% of the fluid; butane, wherein the butane comprises about 15% to 45% of the fluid; isobutane, wherein the isobutane comprises about 15% to 40% of the fluid; and pentane plus, wherein the pentane plus comprises about 5% to 25% of the fluid.

As discussed above, the inventive compositions being water-free will avoid problems that conventional gravel packing fluids cause with regards to clay swelling.

The inventive compositions also contain no viscosity building polymer so there would be no deposition of polymer residue within the reservoir rock pore network. These polymers can be a problem when they do not completely break down over time and plug pore throats, creating an additional pressure drop that impedes oil and gas flow from the reservoir into the wellbore.

The inventive compositions further may eliminate the requirement to perform “well clean-up and flow-back” operations necessary when conventional drilling and completion fluids are used. These fluids must be removed from the reservoir within a short time frame or they can induce formation damage independent of drilling and completion operations. Well clean-up and flow-back operations are often delayed due to unfinished flow line construction, flow-back tank availability, etc. The inventive compositions can avoid these difficulties allowing for greater flexibility in well clean-up operations.

### DETAILED DESCRIPTION OF THE INVENTION

One aspect of using the inventive composition is the benefit realized by injecting gravel packing fluid into an oil reservoir. The Y-grade in the gravel packing fluid can stimulate oil well productivity while also inhibiting the clay swelling and polymer deposition problems associated with water-based gravel packing fluids.

In the first embodiment of the invention, the foam physical properties required of a particular oil or gas well gravel packing operation may be adjusted by altering the individual components. For example, the desired foam physical properties can be achieved by adjusting the gas/liquid phase volume ratio (i.e., foam quality), altering the gas and/or liquid phase compositions, heating or cooling the foam components entering the well, adding liquid or gas phase chemicals, and/or adding solid phase nanoparticles.

In the second embodiment, the composition of the first embodiment is supplemented with a high molecular weight gas to increase its density and extend its use into deeper, higher pressure reservoirs. The addition of a high molecular weight gas such as sulphur hexafluoride will expand the gravel packing depth capability when the composition is formulated with nitrogen and/or carbon dioxide.

The third embodiment builds from the composition of the first embodiment with the addition of a flame retardant chemical. The addition of flame retardant chemicals will likely improve expected safety performance during gravel packing operations, particularly when addressing situations with high Reid Vapor Pressures. Fugitive emissions from the BOP (blowout preventer) stacks can create potential fire hazards, so the addition of a flame retardant chemical can assist in the event that there is a fire hazard at the gravel packing site.

In the fourth embodiment, the organo-silicate nanoparticles added can alter the wettability of the oil reservoir thereby combining gravel packing with oil well stimulation.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

What is claimed is:

1. A composition comprising a mixture of nitrogen gas or carbon dioxide gas, Y-grade fluids mixture, and a surfactant foaming agent.

2. A composition comprising a mixture of nitrogen gas or carbon dioxide gas, Y-grade fluids mixture, a surfactant foaming agent and a high density, non-toxic, inert gas compound.

3. A composition comprising a mixture of nitrogen gas or carbon dioxide gas, Y-grade fluids mixture, and a flame retardant chemical.

4. A composition comprising a mixture of nitrogen gas or carbon dioxide gas, Y-grade fluids mixture, and an organo-silicate nanoparticle.

5. An improved method for performing gravel packing operations of boreholes comprising adding a composition selected from the group of mixtures comprising a mixture of nitrogen gas or carbon dioxide gas, Y-grade fluids mixture, and a surfactant foaming agent; nitrogen gas or carbon dioxide gas, Y-grade fluids mixture, a surfactant foaming agent and a high density, non-toxic, inert gas compound; of nitrogen gas or carbon dioxide gas, Y-grade fluids mixture, and a flame retardant chemical; and nitrogen gas or carbon dioxide gas, Y-grade fluids mixture, and a higher quality foam, as well as containing gas and/or chemical additives that alter its thermal properties.
